(19) United States
(12) Patent Application Publication
(10) Pub. No.: US 2003/0095327 A1
(43) Pub. Date: May 22, 2003

(54) Image-forming methods of an optical microscope and an optical telescope

(76) Inventor: Katsuhiko Shinohara, Kakogawa-shi (JP)

Correspondence Address: Katsuhiko Shinohara, 669-20 Kimura, Kakogawa-choo, Kakogawa-shi, Hyogo, 875-0038, JP

(21) Appl. No.: 09/988,472

(22) Filed: Nov. 20, 2001

(51) Int. Cl. G02B 21/00; G02B 21/06; G02B 5/18; G02B 27/44

(52) U.S. Cl. 359/385; 359/368; 359/566

(57) ABSTRACT

The linear phase diffraction gratings generating a π phase difference are set on the image forming plane of objects, and are scanned in the perpendicular direction of them. Then the image of said objects is obtained by focusing the light transmitted or reflected through said linear phase diffraction gratings, and the diameter of a fixed star is obtained from the graph shape showing a change in the photo-detection quantity while said linear phase diffraction gratings are scanned in the perpendicular direction of them.

### BACKGROUND OF THE INVENTION

The present invention relates to image-forming methods of an optical microscope and an optical telescope.

It was requested that a differential interference microscope have the performance to detect a fainter phase difference than ever, and that it be offered at reasonable prices. It was requested that an optical telescope have the performance to remove the influence of the light reflected from the water or glass surfaces in front of objects and that of flares.

In special applications of said optical telescope, it was also requested that it have a strong tomography effect for detecting the objects in front of trains or cars.

It was requested that an astronomical telescope have the performance to remove the influence of the man-made light and the flares generated by itself and to measure the diameters of fixed stars simply.

### SUMMARY OF THE INVENTION

A purpose of the present invention is to provide image-forming methods of an optical microscope (i.e., a differential interference microscope) and an optical telescope.

This optical telescope has the strong tomography effect to remove the influence of the light reflected or emitted from obstacles before and behind the objects, and has the performance to measure the diameters of fixed stars simply.

And that differential interference microscope has the performance that the fainter phase difference of said objects can be detected than ever, and it can be offered at reasonable prices.

For this purpose, there are linear phase diffraction gratings composed of bisected phase plates on the image-formation plane, and then the optical image of said objects is obtained by detecting the light through them while they are scanned.

### BRIEF DESCRIPTION OF THE DRAWINGS

FIG. 1 shows the block diagram having linear transmission-type phase diffraction gratings of an embodiment.

FIG. 2 shows the block diagram having linear reflection-type phase diffraction gratings of an embodiment.

FIG. 3 shows the block diagram of an embodiment of an optical telescope.

FIG. 4 shows the illustration of the components of a linear transmission-type phase diffraction grating.

FIG. 5 shows the illustration of the components of a linear reflection-type phase diffraction grating.

FIG. 6 shows the photo-detecting surface illustration of the CCD of an embodiment.

FIG. 7 shows the illustration of the phase detection method of a conventional differential interference microscope.

FIG. 8 shows the illustration of the phase detection method of the optical microscope of the present invention.

FIG. 9 shows the graph showing the change in the CCD photo-detection quantity from one light point in a fixed star.

FIG. 10 shows the graph showing the change in the CCD photo-detection quantity from two light points at a distance of 0.5 in a fixed star.

FIG. 11 shows the graph showing the change in the CCD photo-detection quantity from ten light points at intervals of 0.025 in a fixed star.

FIG. 12 shows the graph composed of the pile of two graphs. (graph 11′ in FIG. 11 and the graph obtained at 0.5 shift of it.)

FIG. 13 shows the graph showing the change in the CCD photo-detection quantity from twenty light points at intervals of 0.025 in a fixed star.

### DESCRIPTION OF THE PREFERRED EMBODIMENTS

A few embodiments of the preset invention are explained thereinafter referring to Figures.

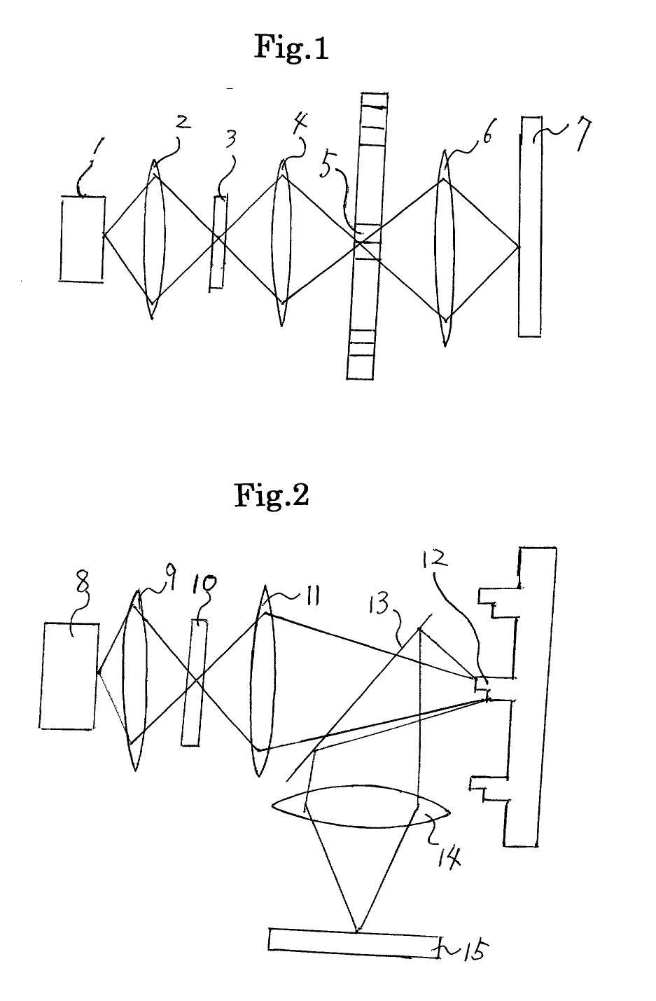

FIG. 1 shows an embodiment using linear transmission-type phase diffraction gratings 5, in this embodiment, the light emitted by a light source 1 is irradiated to a object 3 through a convex lens 2, and the image of said object 3 is magnified-image formed on the plane composed of several linear transmission-type phase diffraction gratings 5.

Then, the light transmitted through said linear transmission-type phase diffraction gratings 5 that exit in slits is focused on a CCD 7 by a convex lens 6.

The optical image of said object 3 is obtained from that on said CCD 7 while all said linear transmission-type phase diffraction gratings 5 are scanned in the perpendicular direction of them.

FIG. 2 shows an embodiment using linear reflection-type phase diffraction gratings 12, in this embodiment, the light emitted by a light source 8 is irradiated to a object 10 through a convex lens 9, and then is focused on said linear reflection-type phase diffraction gratings 12 through a convex lens 11.

Next, the light reflected by said linear reflection-type phase diffraction gratings 12 is gotten out with a half mirror 13, and then is focused on a CCD 15 through a convex lens 14.

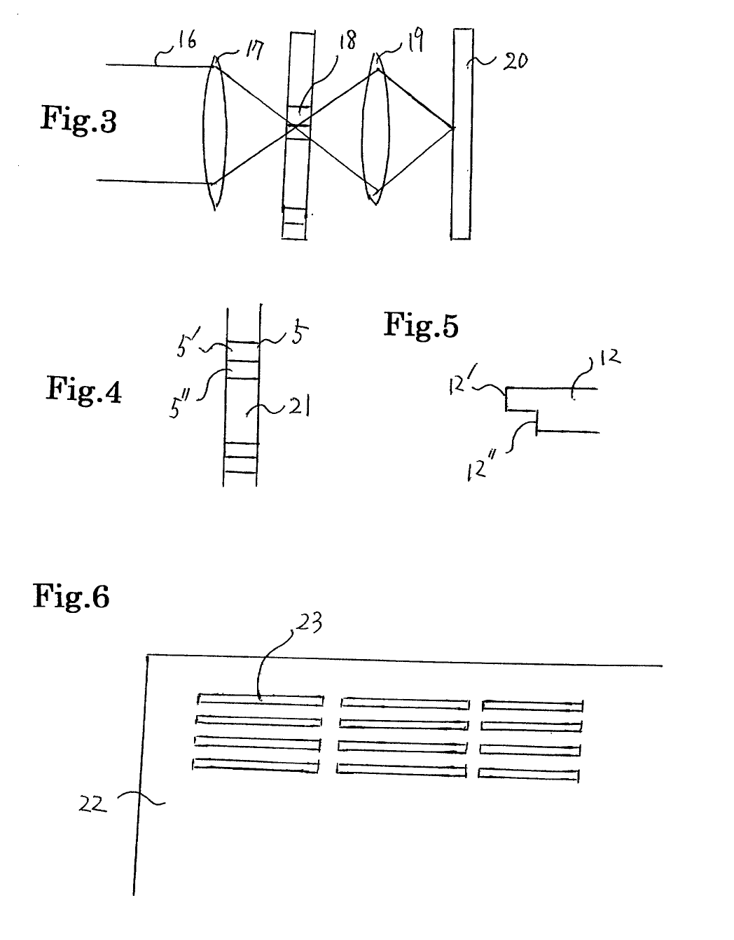

FIG. 3 shows said image-forming method of an optical telescope when we observe said objects, and in this embodiment, the light 16 emitted or reflected by said objects is focused on linear transmission-type phase diffraction gratings 18 through a lens 17.

And then, the light transmitted through said linear transmission-type phase diffraction gratings 18 that exist in slits is focused on a CCD 20 through a lens 19.

The optical image of said objects on the earth and stars is obtained from that on said CCD 20 while all said linear transmission-type phase diffraction gratings 18 are scanned in the perpendicular direction of them.

The diameter of said fixed star is obtained from the shape of a change in the CCD photo-detection quantity during moving of said linear transmission-type phase diffraction gratings 18.

FIG. 4 shows the structure of said linear transmission-type phase diffraction gratings 5 that exist in slits 21 made up of light screens and which have two-divided linear phase plates 5′ and 5″ generating a π phase difference.

FIG. 5 shows the structure of said linear reflection-type phase gratings 12 having two linear mirrors 12′ and 12″ with the difference of one fourth wavelength height.

There are embodiments having several linear transmission-type phase diffraction gratings 5 or 18 or several linear reflection-type phase diffraction gratings 12.

FIG. 6 shows an embodiment that a CCD 22 has long-strip-photo-detecting surfaces 23.

In this embodiment, each long-axis direction of said long-strip-photo-detecting surfaces 23 is set in the moving direction of said linear phase diffraction gratings 5, 12, or 18.

Therefore, it is possible to obtain the image having a high contrast and a high solution.

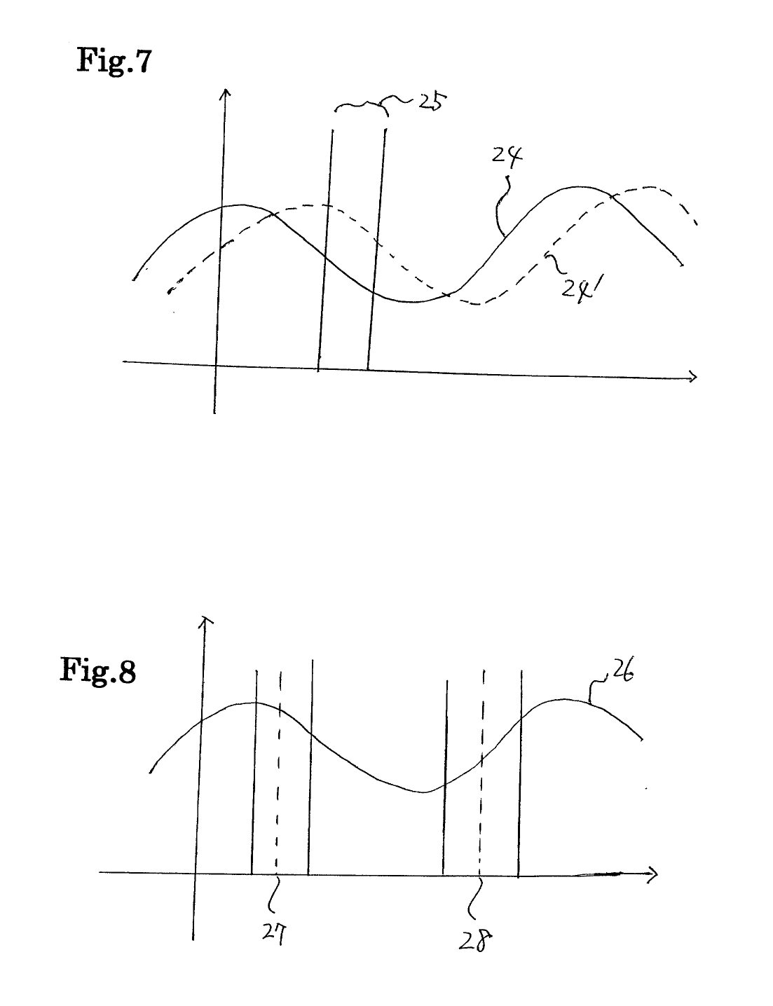

FIG. 7 shows the image-forming method of the conventional differential interference microscope that detects the difference within a constant width 25 between the phase change graph 24 and the phase change graph 24′ obtained by minimal transverse shift of it.

It is therefore difficult for a phase change in said objects to be correctly imaged owing to leveling of the difference between said phase change graph 24 and 24′.

In said image-forming method of an optical microscope of the present invention in FIG. 8, provided that the phase change graph of the image of said objects 3 or 10 on the plane of said linear phase diffraction gratings 5 or 12 is shown by 26, and provided that the center positions at two different minimal parts in said phase change graph 26 are shown by 27 and 28, the continuous measurements of the difference between both sides at positions 27 to 28 can give the accurate change in said phase change graph 26.

An overlap of objects, stray light, and flares reduce the contrast of a image in the method of conventional optical telescopes.

In said image-forming method of an optical telescope of the present invention in FIG. 3, each image of non aimed parts is focused on said linear phase diffraction gratings 18 as a homogeneous large spot.

Therefore, the light transmitted through said transmission-type phase diffraction gratings 18 that exist in the slits does not arrive on CCD 20 through said lens 19: the only image of an aimed part in said objects is obtained through said linear phase diffraction gratings 18 as a tomography of said objects.

Said image-forming method of an optical telescope of the present invention in FIG. 3 is useful for observing said objects under the water, behind the glass, or in the fog, and is useful for taking a picture against the light.

The rain, the snow, and the fog have less influence on the image obtained by said image-forming methods of an optical telescope of this invention than that obtained by conventional laser scanning methods.

The optical telescope of the present invention can distinguish colors, so it is possible to distinguish colors of signal and the men who are working on railroad tracks wearing color belts.

Therefore, it is possible for said optical telescope of the present invention applied to trains to decrease traffic accidents resulting in injury or death and traffic accidents due to rocks etc. on the railroad tracks.

In application to cars, it is possible to find out the men, the other cars, or the traffic light at a constant distance before our driving cars, when the drivers fail to find them through their carelessness.

In this cars, we can detect the moving directions of said men and said other cars, and can distinguish the color of said traffic light.

Provided that the light emitted from a point X in said fixed star is focused on the plane of said linear phase diffraction gratings 18 as the light-intensity distribution shape of the cone of radius 1 and height 1.

Provided that every width of said linear phase diffraction gratings 18 is 2.

And provided that X is equal to zero when the center of the above-mentioned cone lies on a center line of said linear phase diffraction gratings 18.

The light quantity V that arrive on CCD 20 through said linear phase diffraction gratings 18 from a point X in said fixed star is shown as the following equations: (K is a constant)

in the case of 0≦X≦1,0≦Z≦1

$$\begin{matrix}KV = π / 3 - 4 {\int }_{0}^{1 - X} {\int }_{0}^{1 - z - X} \sqrt{{( 1 - z )}^{2} - {( X + x )}^{2}} ⅆ x ⅆ z - \\ 2 {\int }_{0}^{X} {\int }_{0}^{X - z} \sqrt{{( 1 - z )}^{2} - {( 1 + x - X )}^{2}} ⅆ x ⅆ z\end{matrix}$$

in the case of 1<X≦2,0≦z≦1

$$KV = 2 {\int }_{0}^{2 - X} {\int }_{0}^{2 - X - z} \sqrt{{( 1 - z )}^{2} - {( X - 1 + x )}^{2}} ⅆ x ⅆ z$$

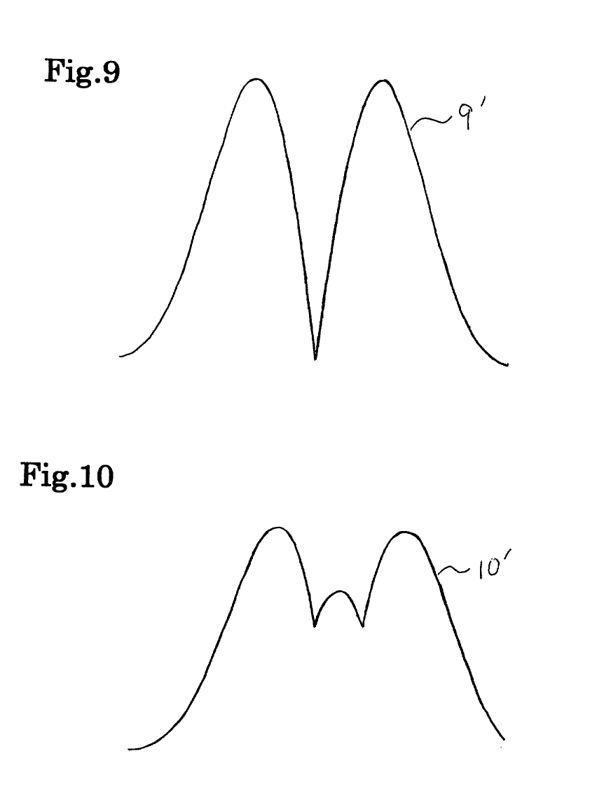

Provided that the transverse axis is X and the longitudinal axis is V, said equations are shown as the graph 9′ in FIG. 9.

The graph 10′ in FIG. 10 is obtained by the addition of said graph 9′ and the graph obtained by a 0.5 transverse shift of said graph 9′.

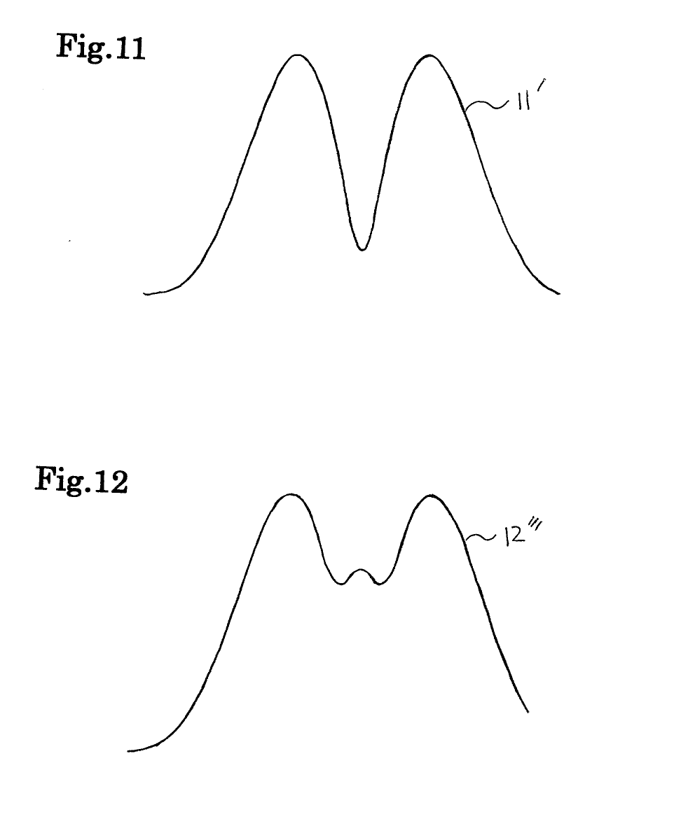

And then the graph 11′ in FIG. 11 is obtained by the addition of ten graphs 9′ continuously moved at intervals of 0.025 in the direction of said transverse axis.

The graph 12′″ in FIG. 12 is obtained by the addition of said graph 11′ in FIG. 11 and the graph obtained by a 0.5 transverse shift of said graph 11′.

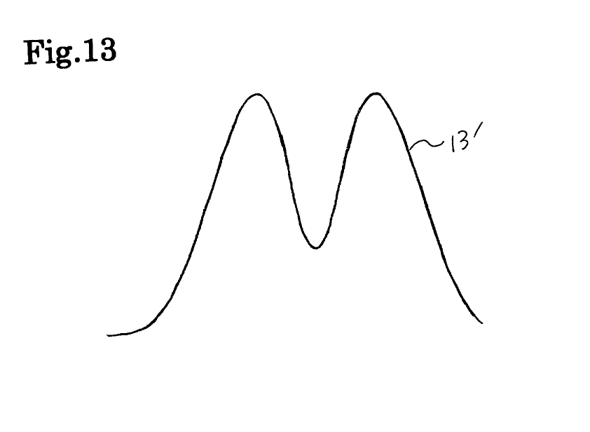

And then the graph 13′ in FIG. 13 is obtained by the addition of twenty graphs 9′ continuously moved at intervals of 0.025 in the direction of said transverse axis.

Said graphs 9′,10′,11′,12′″, and 13′ correspond to the graphs showing the change in the photo-detection quantity arriving on said CCD 20 when only one light point, two light points at a distance of 0.5, ten light points at intervals of 0.025, two groups of said ten light points at intervals of 0.025 (two light-point groups at a distance of 0.5), and twenty light points at intervals of 0.025 exist in said fixed star, respectively.

Therefore, it is possible to obtain the diameter of said fixed star from the graph shapes showing the change in the CCD photo-detection quantity while said linear phase diffraction gratings 18 are scanned in the perpendicular direction of them.

There is an embodiment that the linear phase diffraction gratings are covered by filters of the three primary colors.

In this case, the color image of said objects can be obtained by only one CCD.

While a few embodiments of the invention have been illustrated and described in detail, it is particularly understood that the invention is not limited thereto or thereby.

What is claimed is:

1. image-forming methods of an optical microscope and an optical telescope comprising;
forming the image of objects on linear phase diffraction gratings;
scanning said linear phase diffraction gratings in the perpendicular direction of them;
getting the image of said objects from the light transmitted or reflected through said linear phase diffraction gratings.

2. Said image-forming methods of an optical microscope and an optical telescope of claim 1, wherein each of said linear phase diffraction gratings is divided into two parts by using phase plates generating a π phase difference.

3. Said image-forming methods of an optical microscope and an optical telescope of claim 1, wherein said linear phase diffraction gratings are covered by filters of the three primary colors.

4. Said image-forming methods of an optical microscope and an optical telescope of claim 1, wherein the diameter of a fixed star is obtained from the graph shape showing a change in the detection quantity of the light transmitted or reflected through said linear phase diffraction gratings while they are scanned in the perpendicular direction of them.
